(19) United States
(12) Patent Application Publication
(10) Pub. No.: US 2014/0279569 A1
(43) Pub. Date: Sep. 18, 2014

(54) MANAGING WORKFLOW APPROVAL

(71) Applicant: INTERNATIONAL BUSINESS MACHINES CORPORATION, Armonk, NY (US)

(72) Inventors: Nicholas A. Baldwin, Gladesville (AU); Stefan A. Hepper, San Jose, CA (US); Eric Martinez de Morentin, Manly (AU)

(73) Assignee: International Business Machines Corporation, Armonk, NY (US)

(21) Appl. No.: 13/833,799

(22) Filed: Mar. 15, 2013

(51) Int. Cl. G06Q 10/10

(52) U.S. Cl. CPC G06Q 10/103
USPC 705/301

(57) ABSTRACT

A method, computer program product, and system is described. A target completion date for approval of a content item is identified. One or more approvers associated with a sequence of approval for the content item are identified. A recommended completion date for the content item is determined based upon, at least in part, historical workflow data. Whether timely completion of the approval of the content item is likely is determined based upon, at least in part, comparing the target completion date with the recommended completion date.

### TECHNICAL FIELD

This disclosure relates to workflow management.

### BACKGROUND

A workflow management application (or process) may facilitate the management of workflow for particular content items (e.g., a document, a webpage, a software code segment, and so on) and/or modifications to content items. For example, a workflow management application may be configured to assist in creating, modifying, approving, publishing, or deleting content items, management of various aspects of these tasks, and various other workflow-related functionality. A workflow management application may, for example, facilitate saving of one or more versions of a content item and/or notifying content authors and/or content reviewers or approvers of various assignments, statuses, upcoming events (e.g., due dates), and so on. As such, for example, a workflow management application may generally facilitate the flow of content items and information (e.g., information regarding particular tasks or events) in a workflow system.

Content approval may refer to the process through which approval of a particular content item (and/or revisions thereto) may be managed. It may be desirable, for example, in various settings, to obtain approval from one or more designated individuals for a particular content item before publishing the content (and/or otherwise advancing the content through various stages of creation, refinement, distribution, and so on). In certain instances, it may be appropriate to obtain tiered approval for a content item (e.g., approval from a series of individuals, with the content item being submitted to the next approver(s) in the series based upon receiving approval from the preceding approver(s) in the series).

### BRIEF SUMMARY OF THE DISCLOSURE

According to one aspect of the disclosure, a computer-implemented method includes identifying, by one or more computing devices, a target completion date for approval of a content item. The method includes identifying, by the one or more computing devices, one or more approvers associated with a sequence of approval for the content item. The method includes determining, by the one or more computing devices, a recommended completion date for the content item based upon, at least in part, historical workflow data. The method includes determining, by the one or more computing devices, whether timely completion of the approval of the content item is likely, based upon, at least in part, comparing the target completion date with the recommended completion date.

One or more of the following features may be included. The method may include identifying a last approver in the sequence of approval. The method may include notifying the last approver of one or more of the target completion date and a first amended target completion date, wherein the first amended target completion date is determined based upon, at least in part, determining the recommended completion date. The method may include receiving an indication of a target receipt date for the last approver based upon, at least in part, notifying the last approver of one or more of the target completion date and the first amended target completion date. The method may include identifying a previous approver in the sequence of approval, the previous approver preceding the last approver in the sequence of approval. The method may include notifying the previous approver of the target receipt date for the last approver. The method may include receiving an indication of a target receipt date for the previous approver based upon, at least in part, notifying the previous approver of the target receipt date for the last approver. The method may include determining a projected total approval time based upon, at least in part, one or more of receiving the indication of the target receipt date for the last approver and receiving the indication of the target receipt date for the previous approver. The method may include determining a second amended target completion date based upon, at least in part, determining the projected total approval time.

The method may include identifying completion of approval of the content item. The method may include determining an actual approval time associated with the completion of approval. The method may include amending the historical work flow data to include an indication of the actual approval time. The method may include determining an amended target completion date based upon, at least in part, determining the recommended completion date. The recommended completion date may be later than the target completion date. The recommended completion date may be later than the target completion date by more than a threshold percentage of a total project time.

According to another aspect of the disclosure, a computer program product resides on a computer readable storage medium that has a plurality of instructions stored on it. When executed by a processor, the instructions cause a processor to perform operations including identifying a target completion date for approval of a content item. The operations include identifying one or more approvers associated with a sequence of approval for the content item. The operations include determining a recommended completion date for the content item based upon, at least in part, historical workflow data. The operations include determining whether timely completion of the approval of the content item is likely, based upon, at least in part, comparing the target completion date with the recommended completion date.

One or more of the following features may be included. The operations may include identifying a last approver in the sequence of approval. The operations may include notifying the last approver of one or more of the target completion date and a first amended target completion date, wherein the first amended target completion date is determined based upon, at least in part, determining the recommended completion date. The operations may include receiving an indication of a target receipt date for the last approver based upon, at least in part, notifying the last approver of one or more of the target completion date and the first amended target completion date. The operations may include identifying a previous approver in the sequence of approval, the previous approver preceding the last approver in the sequence of approval. The operations may include notifying the previous approver of the target receipt date for the last approver. The operations may include receiving an indication of a target receipt date for the previous approver based upon, at least in part, notifying the previous approver of the target receipt date for the last approver. The operations may include determining a projected total approval time based upon, at least in part, one or more of receiving the indication of the target receipt date for the last approver and receiving the indication of the target receipt date for the previous approver. The operations may include determining a second amended target completion date based upon, at least in part, determining the projected total approval time.

The operations may include identifying completion of approval of the content item. The operations may include determining an actual approval time associated with the completion of approval. The operations may include amending the historical work flow data to include an indication of the actual approval time. The operations may include determining an amended target completion date based upon, at least in part, determining the recommended completion date. The recommended completion date may be later than the target completion date. The recommended completion date may be later than the target completion date by more than a threshold percentage of a total project time.

According to another aspect of the disclosure, a computing system includes one or more processor devices and one or more memory architectures coupled with the one or more processor devices. The one or more processor devices are configured to identify a target completion date for approval of a content item. The one or more processor devices are configured to identify one or more approvers associated with a sequence of approval for the content item. The one or more processor devices are configured to determine a recommended completion date for the content item based upon, at least in part, historical workflow data. The one or more processor devices are configured to determine whether timely completion of the approval of the content item is likely, based upon, at least in part, comparing the target completion date with the recommended completion date.

One or more of the following features may be included. The one or more processor devices may be configured to identify a last approver in the sequence of approval. The one or more processor devices may be configured to notify the last approver of one or more of the target completion date and a first amended target completion date, wherein the first amended target completion date is determined based upon, at least in part, determining the recommended completion date. The one or more processor devices may be configured to receive an indication of a target receipt date for the last approver based upon, at least in part, notifying the last approver of one or more of the target completion date and the first amended target completion date. The one or more processor devices may be configured to identify a previous approver in the sequence of approval, the previous approver preceding the last approver in the sequence of approval. The one or more processor devices may be configured to notify the previous approver of the target receipt date for the last approver. The one or more processor devices may be configured to receive an indication of a target receipt date for the previous approver based upon, at least in part, notifying the previous approver of the target receipt date for the last approver. The one or more processor devices may be configured to determine a projected total approval time based upon, at least in part, one or more of receiving the indication of the target receipt date for the last approver and receiving the indication of the target receipt date for the previous approver. The one or more processor devices may be configured to determine a second amended target completion date based upon, at least in part, determining the projected total approval time.

The one or more processor devices may be configured to identify completion of approval of the content item. The one or more processor devices may be configured to determine an actual total approval time associated with the completion of approval. The one or more processor devices may be configured to amend the historical work flow data to include an indication of the actual approval time. The one or more processor devices may be configured to determine an amended target completion date based upon, at least in part, determining the recommended completion date. The recommended completion date may be later than the target completion date. The recommended completion date may be later than the target completion date by more than a threshold percentage of a total project time.

According to another aspect of the disclosure, a computer-implemented method includes identifying, by one or more computing devices, a target completion date for approval of a content item. The method includes identifying, by the one or more computing devices, a last approver in a sequence of approval associated with the content item. The method includes notifying, by the one or more computing devices, the last approver of the target completion date. The method includes receiving, by the one or more computing devices, an indication of a target receipt date for the last approver based upon, at least in part, notifying the last approver of the target completion date. The method includes determining, by the one or more computing devices, a previous approver in the sequence of approval, the previous approver preceding the last approver in the sequence of approval. The method includes notifying, by the one or more computing devices, the previous approver of the target receipt date for the last approver. The method includes receiving, by the one or more computing devices, an indication of a target receipt date for the previous approver based upon, at least in part, notifying the previous approver of the target receipt date for the last approver. The method includes determining, by the one or more computing devices, a projected total approval time based upon, at least in part, one or more of receiving the indication of the target receipt date for the last approver and receiving the indication of the target receipt date for the previous approver. The method includes identifying, by the one or more computing devices, a first amended target completion date based upon, at least in part, determining the projected total approval time, wherein the projected total project approval time indicates a likely failure to complete the approval of the content item by the target completion date.

One or more of the following features may be included. The method may include determining a recommended completion date for the content item based upon, at least in part, historical workflow data. The method may include determining whether one or more of the target completion date and the first amended target completion date are appropriate for timely approval of the content item, based upon, at least in part, comparing the recommended completion date with one or more of the target completion date and the first amended target completion date. The method may include identifying a second amended target completion date based upon, at least in part, comparing the recommended completion date with one or more of the target completion date and the first amended target completion date. The method may include identifying completion of the approval of the content item. The method may include determining an actual approval time associated with the completion of the approval. The method may include amending the historical work flow data to include an indication of the actual approval time.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of an approval management process coupled to a distributed computing network;

FIG. 2 is a flowchart of a process executed by the approval management process of FIG. 1;

FIG. 3 is a diagrammatic view of an aspect of the approval management process of FIG. 1.

FIG. 4 is a diagrammatic view of an aspect of the approval management process of FIG. 1.

Like reference symbols in the various drawings indicate like elements.

### DETAILED DESCRIPTION OF THE PREFERRED EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

A workflow management application (or process) may facilitate the management of workflow for particular content items (e.g., a document, a webpage, a software code segment, and so on) and/or modifications to content items. For example, a workflow management application may be configured to assist in creating, modifying, approving, publishing, or deleting content items, management of various aspects of these tasks, and various other workflow-related functionality. A workflow management application may, for example, facilitate saving of one or more versions of a content item (e.g., to a storage device associated with the workflow management application) and/or notifying content authors and/or content reviewers or approvers of various assignments, statuses, upcoming events (e.g., due dates), and so on. As such, for example, a workflow management application may generally facilitate the flow of information (e.g., information regarding particular tasks or events) in a workflow system.

Content approval may refer to the process through which approval of a particular content item (and/or revisions thereto) may be managed. It may be desirable, for example, in various settings, to obtain approval from designated individuals for a particular content item before publishing the content (and/or otherwise advancing the content through various stages of creation, refinement, distribution, and so on). In certain instances, it may be appropriate to obtain “tiered” or “serial” approval (i.e., approval from a series of individuals, with the content being submitted to the next approver(s) in the series based upon receiving approval from the preceding approver(s) in the series).

In certain instances, the life cycle schedule of a content item may require that the item be ready for publication or distribution (and/or otherwise at a particular stage of completion or approval) by a certain date. For example, an administrator (e.g., the author of the content) may designate a particular target publication/distribution date, and/or a target publication/distribution date may be determined based on a variety of other criteria. This may present difficulties, for example, in the case where serial approval is required before publication/distribution. For example, it may be difficult to manage successive approval by various tiers of approvers in order to ensure that the content item has been appropriately approved by the target date. Similarly various other issues may arise with respect to managing approval of content items. An approval management (“AM”) process (or application) may provide this and/or various other functionality. For example, an AM process may facilitate identification of an appropriate length of time for a serial (and/or other) approval process based upon a target publication date and/or historical data relating to similar prior approval of similar content items. In certain embodiments, an AM process may facilitate determining and assigning target dates for approval relating to each of several tiers of approval in order to assist in timely completion of all approvals before a target publication/distribution date for a content item. For example, for a given order of approval in a tiered approval workflow, an AM process may receive information from approvers in reverse order (e.g., first receiving information from the last approver in the workflow) in order to successively designate target approval dates for various of the tiers of approvers.

Referring now to FIG. 1, an AM process may be coupled to a computer or computer network. For example, server AM process 10 may reside on and may be executed by server computer 12, which may be connected to network 14 (e.g., the Internet or a local area network). Examples of server computer 12 may include, but are not limited to: a personal computer, a server computer, a series of server computers, a mini computer, and/or a mainframe computer. Server computer 12 may be a web server (or a series of servers) running a network operating system, examples of which may include but are not limited to: Microsoft® Windows Server®; Novell® Netware®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.)

The instruction sets and subroutines of server AM process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft® IIS, Novell® Web Server™, or Apache® Web Server, that allows for access to server computer 12 (via network 14) using one or more protocols, examples of which may include but are not limited to HTTP (i.e., HyperText Transfer Protocol), SIP (i.e., session initiation protocol), and the Lotus® Sametime® VP protocol. (Webserver is a trademark of Novell Corporation in the United States, other countries, or both; Apache is a registered trademarks of Apache Software Foundation in the United States, other countries, or both; Lotus and Sametime are registered trademarks of International Business Machine Corp. in the United States, other countries, or both.) Network 14 may be connected to one or more secondary networks (e.g., network 18), examples of which may include but are not limited to: a local area network; a wide area network; or an intranet, for example.

Client AM processes 20, 22, 24, 26 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 14 and/or network 18 and may each execute an operating system, examples of which may include but are not limited to Microsoft® Windows®, Microsoft Windows CE®, Red Hat® Linux®, or a custom operating system.

The instruction sets and subroutines of client AM processes 20, 22, 24, 26, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

In an embodiment, the AM process may be a server-side process (e.g., which may be implemented via server AM process 10), in which all of the functionality of the AM process may be executed on a server computer (e.g., server computer 12). In an embodiment, the AM process may be a client-side process (e.g., which may be implemented via one or more of client AM processes 20, 22, 24, 26), in which all of the functionality of the AM process may be executed on a client computing device (e.g., one or more of client electronic devices 28, 30, 32, 34). In an embodiment, the AM process may be a hybrid server-client process (e.g., which may be implemented by server AM process 10 and one or more of client AM processes 20, 22, 24, 26), in which at least a portion of the functionality of the AM process may be implemented via server computer 12 and at least a portion of the functionality of the AM process may be implemented via one or more client computing devices (e.g., one or more of client electronic devices 28, 30, 32, 34).

In certain embodiments, an AM process may be a stand-alone process. In certain embodiments, an AM process may operate as part of, or in conjunction with, one or more other processes and/or may include one or more other processes. For example, in certain embodiments, an AM process may be included in (or may operate in conjunction with) a workflow management (“WM”) application (or process), which may generally facilitate the management of workflow for particular content items (e.g., a document, a webpage, a software code segment, and so on) and/or modifications to content items. For example, as also noted above, a workflow management application may be configured to assist in creating, modifying, approving, publishing, or deleting content items, management of various aspects of these tasks, and various other workflow-related functionality. A WM application may, for example, facilitate saving of one or more versions of a content item and/or notifying content authors and/or content reviewers or approvers of various assignments, statuses, upcoming events (e.g., due dates), and so on. As such, for example, a WM application may generally facilitate the flow of information (e.g., information regarding particular tasks or events) in a workflow system.

A WM application (or process) may operate (and/or reside) on a client device (e.g., client WM application 44, operating on client electronic device 28; client application WM 46, operating on client electronic device 30; client WM application 48, operating on client electronic device 32; or client WM application 50, operating on client electronic device 34). A client AM process (e.g., client AM process 20) or a server AM process (e.g., server AM process 10) may be in communication with a client WM application (e.g., client WM application 44) or may be part of a client WM application.

A WM application may additionally/alternatively operate (and/or reside) on a server device (e.g., server WM application 52, operating on server computer 12 or another server WM application (not shown), operating on another server computer (not shown)). A server AM process (e.g., server AM process 10) or a client AM process (e.g., client AM process 20) may be in communication with a server WM application (e.g., server WM application 52) or may be a part of a server WM application.

Users 54, 56, 58, 60 may access an AM process in various ways. For example, these users may access server AM process 10 directly through the device on which a client process (e.g., client AM processes 20, 22, 24, 26) is executed, namely client electronic devices 28, 30, 32, 34. Users 54, 56, 58, 60 may access server AM process 10 directly through network 14 and/or through secondary network 18. Further, server computer 12 (i.e., the computer that executes server AM process 10) may be connected to network 14 through secondary network 18, as illustrated with phantom link line 62. Users 54, 56, 58, 60 may also access a client or server WM application (or process) in similar ways.

The various client electronic devices may be directly or indirectly coupled to network 14 (or network 18). For example, personal computer 28 is shown directly coupled to network 14 via a hardwired network connection. Further, notebook computer 34 is shown directly coupled to secondary network 18 via a hardwired network connection. Laptop computer 30 is shown wirelessly coupled to network 14 via wireless communication channel 64 established between laptop computer 30 and wireless access point (“WAP”) 66, which is shown directly coupled to network 14. WAP 66 may be, for example, an IEEE 802.11a, 802.11b, 802.11g, 802.11n, Wi-Fi, and/or Bluetooth device that is capable of establishing wireless communication channel 64 between laptop computer 30 and WAP 66. Data-enabled mobile telephone 32 is shown wirelessly coupled to network 14 via wireless communication channel 68 established between data-enabled mobile telephone 32 and cellular network/bridge 70, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

For the following discussion, client AM process 20 will be described for illustrative purposes. It will be understood that client AM process 20 may, for example, interact and/or communicate with a server AM process such as server AM process 10 and/or may be executed within one or more applications that allow for communication with other server and/or client AM processes. This is not intended to be a limitation of this disclosure, as other configurations are possible (e.g., AM process 20 may include stand-alone client processes and/or stand-alone server processes). For example, some implementations may include one or more of client AM processes 22, 24, 26 or server AM process 10 in place of or in addition to client AM process 20.

Referring now also to FIG. 2, there is shown a diagrammatic view of an example process that may be implemented by an AM process, e.g., client AM process 20. For example, client AM process 20 may identify 200 a target completion date for approval of a content item. (e.g., approval through a workflow process; e.g., using a WM application). For example, an author of a content item, an administrator, or another individual may specify (e.g., via a WM application, such as WM application 44) a particular target completion date for approval of a content item. In certain embodiments, for example, a target completion date for approval of a content item may be a target date for publication/distribution of the content item, or a date sufficiently in advance of such a target publication/distribution date in order to facilitate various administrative and/or other tasks that may need to occur between the final approval of a content item and the publication/distribution of the item. (As used herein, the term “date” will be understood to mean a point or range in time, which may accordingly refer to a particular calendar day (or days), a particular clock time, and/or a range of calendar days or clock times.)

In certain embodiments, a target completion date for approval may not be directly related to a target publication/distribution date. For example, in certain embodiments a workflow (e.g., the tasks, procedural, administrative or substantive steps, organizations, groups or individuals, required information (for input and/or output), and tools needed for each step in a business process) for a particular content item (e.g., a benchmark draft of a report) may require that the content item be approved by a number of individuals before work on a subsequent iteration of the item (e.g., a subsequent draft of the report) may begin. Accordingly, for example, the target completion date for approval may be associated with a target date to start work on the next iteration of the item (e.g., the subsequent draft of the report) rather than a target date for publication/distribution of the item.

In certain embodiments, AM process 20 may identify various other information associated with an identified 200 target completion date for approval of a particular content item (e.g., based upon input from a user into an WM application). For example, AM process 20 may identify, in addition/as an alternative to identifying 200 a target completion date for approval of a content item, a target date for submission of an item for approval. For example, in certain embodiments, a particular content item may need to be submitted to a WM application for approval before it may be sent to various approvers for review. Accordingly, for example, it may be useful to identify the target date for such a submission (i.e., the date on which the content item may be available for review), as well as various other workflow-related information associated with the content item.

AM process 20 may identify 202 one or more approvers associated with a sequence of approval for the content item. For example, based upon information from a WM application, AM process 20 may identify 202 that a series of approvers have been assigned to review a particular content item (and/or various content items associated with a particular workflow, author, working group, corporate division, and so on). In certain embodiments, AM process 20 may identify 202 a particular order of approval associated with the identified 202 approvers. For example, AM process 20 may identify 202 (e.g., based upon workflow information available through WM application 44) that a particular content item is to be approved by a series of approvers in a particular order, with submission of the content item for approval to the next approver in the series of approvers being triggered (and/or enabled) by the receipt of approval for the content item by the preceding approver in the series. This may be useful, for example, in a tiered corporate organization, in which it may be useful for mid-level reviewers (e.g., group leaders, section managers, and so on) to review and approve a content item prior to the content item being submitted to higher-level reviewers (e.g., vice presidents, senior executives, and so on). In certain embodiments, one or more stages in a series or sequence of approval may be associated with multiple approvers. For example, in certain embodiments approval at a primary (or other) stage of approval may possibly be provided by one or more of several approvers, with the content item advancing to the next stage of approval (i.e., according to the relevant workflow) after receiving approval from a particular approver (or approvers) out of the several approvers associated with the primary (or other) stage. For example, initial approval of a particular content item may be assigned to three approvers, with the content item advancing to the next stage of approval (e.g., which may similarly be associated with one or more approvers) upon receipt of approval from two of the three initial approvers.

AM process 20 may determine 204 a recommended completion date for the content item based upon, at least in part, historical workflow data. A recommended completion date may be a date, determined 204 by AM process 20, that is a recommended date for completion of approval of a content item. AM process 20 may determine 204 a recommended completion date based on various information, including, for example, the expected date for submission of the content item for approval (e.g., as provided to WM application 44 by the content author or another user, and/or as estimated based upon historical patterns of submission of similar content items for approval by relevant content authors) and/or the expected amount of time that may be required for approval of the content item by each of a series of required approvers (e.g., as determined based upon analysis of the time required for approval of similar historical content items and/or completion of similar workflows).

Continuing the discussion above, in order to determine 204 a recommended completion date, AM process 20 may analyze various historical workflow data (or information). For example, various historical workflows including content approval may be determined to exhibit similar characteristics (e.g., with respect to approval of content items) to a current workflow, with respect to the particular content item to which the current workflow relates, the author of the content item, the designated series of approvers, and so on. For example, historical workflow information may indicate that a particular series of approvers typically and collectively require a particular amount of time to approve a particular content item type that was created or edited by a particular content author or reviewed and/or approved by one or more particular approvers. For example, if a current content item, content author, and/or series of approvers is similar to a content item, content author, and/or series of approvers represented by historical workflow information, it may be possible to utilize the historical information (e.g., an amount of time historically required for approval of similar content items by similar series of approvers) in order to estimate a likely amount of time that may be required for approval of the current content item. For example, if a set of four approvers has historically required about 8 days to sequentially approve various historical project status updates created by a particular content author (and/or other authors), AM process 20 may determine 204 that the same set of approvers may require about 8 days to sequentially approve a similar (current) project status update created by the particular content author. In certain embodiments, this information may be analyzed in combination, for example, with a target submission date for the content item (e.g., as input into a WM application regarding this particular workflow and/or as determined based upon historical workflow data regarding the timing of submission of similar content items for approval) in order to determine 204 a recommended completion date for the workflow (e.g., an estimate of the total amount of time that is likely to be required for submission of the content item and full approval of the content item by a series of approvers).

It will be understood that the examples above are not exhaustive with respect, for example, to the types of historical (and current) workflow data that may be relevant to determining 204 a recommended completion date. For example, continuing the discussion above, historical workflow data may indicate that the 8 days for approval may be increased by about 1.5 days for each additional ten pages beyond the average project status update length of 45 pages, and may be decreased by about 0.5 days for each additional co-author of such a content item (e.g., because multiple co-authors tend to collaboratively produce a better work product than a single author working alone). Accordingly, if the current content item is a 55 page project update with one co-author in addition to the above-referenced content author, AM process 20 may determine 204 (based upon this historical data) that the four approvers may require approximately 9 days to approve the content item. Similarly, information such as the current date, the type of project, various aspects of a content item, the corporate unit responsible for originating and/or reviewing a content item, calendar information (e.g., indications that a reviewer is out of office for the next two weeks), organizational hierarchy information (e.g., the rank of a content creator and/or reviewer within a corporation), and so on, may be utilized, in certain embodiments, in determining 204 a recommended completion date.

In certain embodiments, AM process 20 may determine 206 whether timely completion of approval of the content item (and/or of another portion of the workflow process) is likely, based upon, at least in part, comparing 208 the target completion date with the recommended completion date. For example, if the determined 204 recommended completion date (e.g., an estimate of the total amount of time for submission and approval of a content item, as determined 204, for example, based upon, at least in part, historical workflow data) is later than the identified 200 target completion date, AM process 20 may determine 206 that timely completion of the approval (and/or the workflow) is not likely. If, for example, the determined 204 recommended completion date falls a long time (e.g., many hours, days, weeks, or months, depending on the context) after an identified 200 target completion date, AM process 20 may determine 206 that timely completion of the approval (and/or the workflow) is particularly unlikely. In certain embodiments, this (and related) information may be provided to various individuals (e.g., various content authors and/or workflow originators).

In certain embodiments, AM process 20 may determine 210 an amended target completion date. For example, AM process 20 may determine 210 a new target completion date that is different from the identified 200 target completion date based upon, at least in part, determining 206 that a workflow is not likely to be completed by the identified 200 target completion date (e.g., based upon comparing 208 the determined 204 recommended completion date with the identified 200 target completion date). For example, if the recommended completion date is determined 204 to be later than the identified 200 target completion date, AM process 20 may determine 210 an amended target completion date that may be on (or after) the recommended completion date and may, in certain embodiments, provide the amended target completion date (and/or various related information) to a user (e.g., the content author, a workflow administrator, and/or various users of a WM application) as a recommended new target completion date (and/or in various related forms).

Continuing the discussion above, for example, if an identified 200 target completion date for a project status update is 10 days away and AM process 20 has determined 204 that the recommended completion date for this content item is 12 days away (e.g., based upon identifying that the draft update is to be submitted for approval in 3 days and that a likely total approval time, based upon historical workflow data, is 9 days), AM process 20 may determine 206 that timely completion of the approval (and/or the workflow) is unlikely and may alert one or more users (e.g., the content author(s), a workflow administrator, and so on) of this information. AM process may similarly provide to a user the determined 204 recommended completion date (e.g., as a determined 210 amended target date), and/or various related information such as the target date for submission of the content item for approval, the likely total approval time, and various other aspects of the current workflow for the current content item (e.g., a list of approvers, and so on). Such information may, for example, facilitate the user (and/or one or more processes or applications) determining an appropriate adjustment (if any) to the workflow in order to better assure the timely completion of the relevant approval 9 and/or the workflow). For example, in certain embodiments, a workflow administrator, based upon, for example, receiving information relating to a determined 204 recommended completion date, may change the target date for submission of the content item for approval, may add, subtract, or substitute approvers with respect to the current workflow, may identify a new target completion date (e.g., a date by which full approval should be completed), and so on. In certain embodiments, upon such a selection of new workflow parameters (and/or the occurrence of various other related events), AM process 20 may execute iteratively (in whole or in part) in order, for example, to determine 204 a new recommended completion date, determine 206 whether timely completion of approval (and/or other aspects the amended workflow) is likely, determine 210 a new amended target completion date for the amended workflow, and so on.

In certain embodiments, an AM process 20 may determine 210 an amended target completion date based upon a determined 204 recommended completion date being later than an identified 200 target completion date by a threshold percentage of a total project time (i.e., the time between the current date and the identified 200 target completion date). For example, given the potential uncertainty in determining 204 a recommended completion date based upon historical workflow data, if the determined 204 recommended completion date is only slightly after the identified 200 target completion date, with respect to the total time for the project, it may not be necessary to determine 210 an amended target completion date in order to ensure likely completion of the workflow in a timely manner. For example, if the total project time for a workflow is 3 months and the determined 204 recommended completion date is only 1 day after the identified 200 target completion date, it may be appropriate not to determine 210 an amended target completion date. However, if the total project time for a workflow is 12 hours and the determined 204 recommended completion date is 4 hours after the identified 200 target completion date, it may be desirable to determine 210 an amended target completion date. It will be understood, however, that it may be useful and/or desirable to provide various information relating to a determined 204 recommended completion date to a user (e.g., as described above) regardless of whether AM process 20 does or does not determine 210 an amended target completion date.

As also noted above, determining 204 a recommended completion date for a workflow may include determining a recommended date for submission of a content item for approval. This may be useful, for example, where the identified 200 target completion date is fixed and where it may not be possible to amend certain other aspects of a workflow, such as the identity of required approvers. For example, if a website update must be published on March 31, three required (and unchangeable) approvers must approve the changes before publication, and the three approvers have historically and collectively taken 20 days to approve similar content items, as part of determining 204 a recommended completion date for the workflow AM process 20 may determine that a recommended due date for submission of the website changes to the first approver may be March 11. Intermediate due dates (e.g., a due date for completion of approval by the first approver) may additionally/alternatively be similarly determined.

In certain embodiments, a determined 210 amended target completion date may be sooner in time than an identified 200 target completion date. For example, if the identified 200 target completion date is 25 days away (including a target of 10 days after the workflow begins for submission of the content item to the first approver) and the determined 204 recommended completion date is 15 days away (including, for example, submission of the content item for approval after the first 10 days and a determined 204 likely approval time of 5 days thereafter), it may be appropriate to determine 210 an amended target completion date (e.g., a date 15 days hence) that precedes the identified 200 target completion date (i.e., a date 25 days hence). As above, such a determined 210 amended target completion date may be determined 210 automatically and/or based upon various user input (e.g., input from a workflow administrator after the administrator has been provided various information relating to the identified 200 target completion date and the determined 204 recommended completion date).

It will be understood that a determined 210 amended target completion date may be the same date as a determined 204 recommended completion date or may be a different date. For example, AM process 20 may determine 210 an amended target completion date based upon providing the determined 204 recommended completion date to a user and receiving various input(s) from the user indicating an appropriately amended target completion date. For example, upon receiving a determined 204 recommended completion date that is two weeks after the identified 200 target completion date, a user (e.g., a content author or workflow administrator) may determine that such a completion date is too far into the future (e.g., is too late to take advantage of a particular business opportunity that would be addressed by the content item) and may accordingly indicate (based upon the information that timely completion of approval under the original schedule is unlikely) that an appropriate amended target completion date is one week after the identified 200 target completion date. In such a case, in certain embodiments and as may be appropriate, AM process 20 may accordingly recommend adjustment of various other workflow parameters, such as the sequence of approvers, in order to ensure a high likelihood of timely completion of the workflow.

In certain embodiments, AM process 20 may additionally/alternatively determine whether sufficient time has been allocated for approval based on analyzing information relating to a series of approvers. For example, AM process 20 may identify 212 an approver in a sequence of approval (e.g., an approver from among the various identified 202 approvers). AM process 20 may then notify 214 the identified 212 approver of a target completion date for approval of the content item by the identified 212 approver. For example, if the identified 212 approver is the last approver in a series of approvers, AM process 20 may notify 214 the approver of an identified 200 original completion date, a determined 204 recommended completion date, a determined 210 amended target date, and/or another target date (e.g., a target completion date determined based on an earlier iteration of various of the processes relating to identified 212 approvers that are described herein, or an identified 200 completion date minus sufficient time to permit various necessary administrative tasks between final approval and publication/distribution), each of which may, for example, relate to a target date for publication/distribution of a fully approved content item. If, for example, the identified 212 approver is not the last approver in a series of approvers, AM process 20 may notify 214 the identified 212 (non-final) approver of a target date for completion of that approver's review so that any subsequent approver(s) may have sufficient time to review and approve the content item before the target completion of the current workflow (which target date may be determined, for example, as further described herein).

AM process 20 may receive 216 an indication of a target receipt date for the notified 214 approver. For example, upon receiving a notification 214 of an appropriate target date for completion of her approval, an approver may determine that she will need three days to adequately review the relevant content item and may accordingly indicate this determination to AM process 20 (e.g., through a user input). In certain embodiments, AM process 20 may assist in this determination by, for example, suggesting an appropriate time span for such review based upon historical workflow data relating to the particular approver, the particular content item, and so on.

Based upon receiving 216 such an indication of a target receipt date, AM process 20 may subsequently identify 212 an earlier approver in the sequence of approval (e.g., the approver immediately preceding the approver providing such an indication), notify 214 the earlier approver of the target receipt date for the later approver (e.g., as determined based upon the received 216 indication), and receive 216 an indication of a target receipt date for the earlier approver. In this way, for example, AM process 20 may iteratively identify 212 approvers and receive 216 appropriate indications of target receipt dates, starting with the last approver in a series of approvers and progressing in reverse order to the first approver in a series of approvers, in order to determine an appropriate total amount of approval time for a workflow, with associated target dates for completion of approval by various approvers determined so as to facilitate timely provision of the content item to the next approver, respectively, in the sequence of approval. For example, by starting with the last approver and working forward, AM process 20 may determine 218 a projected total approval time (e.g., may estimate the total amount of time required to obtain complete approval from a series of approvers) based upon, at least in part, such a set of inputs received 216 from the various approvers. If appropriate, AM process 20 may additionally/alternatively, for example, determine 220 an appropriate amended target completion date (which may vary, for example, from other amended target dates, such as an otherwise determined 210 amended target completion date). For example, if the determined 218 projected total approval time is after an identified 200 target completion date, determined 204 recommended completion date, and/or determined 210 amended target completion date, AM process 20 may determine that timely approval of the content item is unlikely. Accordingly, AM process 20 may determine 220 a new amended target completion date that appropriately accounts for the determined 218 projected total approval time.

In certain embodiments, at various points in the processes described above, various information may be provided to various users in order, for example, to facilitate appropriate adjustment of various workflow parameters. For example, one or more target receipt dates (e.g., as determined from received 216 indications), a determined 218 projected total approval time, and/or one or more target dates for approval by one or more particular approvers may be provided to a workflow administrator in order to facilitate appropriate adjustment of workflow parameters (e.g., a target completion date, the composition and/or order of a sequence of approvers, a target date for submission of a content item for approval, and so on).

In certain embodiments, one or more of determining 220 an amended target completion date, determining 218 a project total approval time, and so on may occur based upon (or in combination with) analysis of historical workflow data. For example, upon notifying 214 an approver of a target date for approval for a content item, AM process 20 may also notify the approver that, based upon analysis of historical workflow data, it appears that approval of similar content items has historically required a certain amount of time for that approver (and/or other approvers).

In certain embodiments in which a given stage of approval may include (at least potentially) multiple approvers, AM process 20 may determine whether sufficient time has been allocated for approval based on analyzing information relating to the series of approvers (including the multiple approvers for the given stage) in a variety of ways. For example, in certain embodiments AM process 20 may notify 214 multiple approvers associated with a particular stage of approval, and may select as a primary/designated approver the first of the notified 214 approvers to respond. Accordingly, for example, AM process 20 may receive 216 an indication of a target receipt date for the first-responding approver (as the selected primary/designated approver) and may proceed accordingly with determining 218, 220 a projected total approval time, an amended target completion date, and so on (e.g., may determine 218 a projected total approval time based upon the indicated target receipt date for the first-responding approver, and so on). Additionally/alternatively, AM process 20 may notify 214 the multiple approvers associated with a particular stage, may receive 216 an indication of respective target receipt dates for various of the approvers, and may select as a primary/designated approver an approver who has indicated (e.g., through the indication of a target receipt date) that she will likely be able to complete approval the fastest. It will be understood that other configurations may additionally/alternatively be possible. For example, AM process 20 may notify 214 only a subset of possible approvers for a particular stage of approval (e.g., based upon organizational hierarchy, project team membership, and/or various system settings), may notify 214 various approvers and select a primary/designated approver based on various factors including, for example, a combination of the timing of any response from the notified 214 approvers and analysis of the various received 216 target receipt dates, and so on. For example, AM process 20 may select as a primary/designated approver the approver who has the shortest projected review time of the approvers who have responded to the notification 214 within a particular timeframe.

In certain embodiments, AM process 20 may additionally/alternatively execute various functionality with respect to multiple content items. For example, content items within a particular set of content items may be similar in various ways (e.g., may each relate to a particular project/topic/author/due date/etc.), and it may accordingly be appropriate to associate these content items with each other with respect to various workflow tasks, functionality or settings. In certain embodiments, for example, content items in an associated set of content items may share one or more aspects with respect to relevant workflow(s) (e.g., may share a designated sequence or set of approvers, or portion thereof) and it may accordingly be appropriate for AM process 20 to group these items with respect to various functionality. For example, if a set of items is subject to an single approval workflow (or closely similar approval workflows), AM process 20 may execute various functionality (e.g., determining 204 a recommended completion date based upon historical workflow data, determining 210 an amended target completion date, notifying 214 approvers of target approval dates, determining 220 an amended target completion date based upon receiving 216 various indications of target receipt dates for approvers, and so on) simultaneously, near-simultaneously, or otherwise similarly, with respect to the set of items. For example, a single notification 214 for the collective set of items may be sent to each respective approver (with or without the option for the approver to indicate different target receipt dates for the different items), and so on.

In certain embodiments, grouping (and/or coordinated execution) of relevant functionality with respect to related content items may be based on various factors in addition/as an alternative to those discussed above. For example, if a set of related content items are subject to different approval workflows, but share a common set of approvers (e.g., if the set of approvers for a particular stage of approval for each content items overlaps with respect to one or more approvers), AM process 20 may select as a primary/designated approver (e.g., in a similar manner and/or with similar effects as discussed above) approvers included in the common set. For example, AM process 20 may preferentially select as primary/designated approvers, with respect to a particular stage of approval, approver(s) from the subset of overlapping approvers, thereby potentially increasing the efficiency of the review process.

AM process 20 may additionally/alternatively update and/or otherwise amend historical workflow data based upon information relating to a current (and/or recently completed) workflow. For example, AM process 20 may identify 222 partial and/or total completion of approval of the content item. For example, AM process 20 may identify 222 the submission of a content item for approval, completion of various stages of approval, completion of all approvals, and/or publication/distribution of the fully approved content item. As such, AM process 20 may determine 224 the actual approval time associated with completion of the approval and/or various stages of the workflow, such as submission of the content item for approval, completion of various stages of the approval, and/or publication/distribution of the fully approved content item. In certain embodiments, AM process 20 may accordingly amend 226 historical workflow data to account for the determined 224 total approval time (and/or various other aspects of the workflow). In this way, for example, historical workflow data may be continually updated in order to further refine the various analyses performed by AM process 20 with respect to such data (and various current workflows).

Referring now also to FIG. 3, a workflow may include a series of sequential steps, including creation 300 of a content item, approval 302 by a first approver, approval 304 by a second approver, approval 306 by a final approver, and publication 308 by a target publication date. AM process 20 may, for example, assist in determining an appropriate publication date, based on historical workflow data relating to the three designated approvers (and/or various other information). For example, upon creation of the workflow for the content item, AM process 20 may identify 200 a target completion date (e.g., based upon an input from a workflow administrator), may identify 202 the various approvers in the sequence of approver, and may determine 204 a recommended completion date based upon historical workflow data (e.g., data regarding the historical approval of content items similar to the current content item by sequences of approvers similar to the current sequence of approvers). If appropriate (e.g., based upon determining 206 whether timely approval (and/or completion of other aspects of the workflow) is likely), AM process 20 may determine 210 an amended target completion date and the workflow for the current content item may be updated/amended accordingly.

AM process 20 may (additionally/alternatively) solicit input from the various approvers in order to facilitate determining 220 (if necessary or appropriate) an amended target completion date. For example, based upon identifying 200 the publication date as a target completion date (and identifying any time required between final approval of the content item and publication—e.g., time for administrative processing), AM process 20 may identify a target date for completion of approval by the final approver and may notify 214 the final approver of this date. Based upon various input from the final approver (e.g., as provided by the approver in response to the notification 214), AM process 20 may receive 216 an indication of a target receipt date (e.g., a date corresponding to the date by which the final approver desires to receive the content item from the previous approver in order to ensure completion of the final approver's review by the target date for completion of that review). Based upon receiving 216 such an indication, AM process may determine a target date for completion of the previous approver's review (e.g., the received 216 target receipt date for the final approver, minus any intermediary time, such as may be required for administrative processing), and may notify 214 the previous (i.e., second) approver of the target date for her approval. This may be continued, for example, moving in reverse order through the reviewers, until target completion dates have been received 216 for all approvers (and may be iterated as appropriate) in order to determine 218 an estimated total approval time for the workflow. If appropriate, AM process 20 may then determine 220 a (new) amended target completion date, provide the determined 220 amended target completion date (and/or related information) to relevant individuals and/or execute various successive iterations of various aspects of AM process 20 in order to further refine the subject workflow.

Upon completion of the workflow (and/or at various intermediary stages), AM process 20 may identify 222 completion of the approval process (and/or the various intermediary stages), may determine 224 a total approval time (and/or a total time for completion of various intermediary stages), and may amend 226 the historical workflow data to account for the progress and/or completion of the current project workflow.

Referring now also to FIG. 4, in certain embodiments, a time-sensitive content item may be created 400 and may be introduced into a WM application workflow. An administrator (e.g., the author of the content item and/or the originator of the workflow) may select 402 a target publication date and/or various other aspects of the project workflow (e.g., identity of approvers, sequence of approval, and so on) and may provide (directly or indirectly) that date and/or other information to the WM application and/or AM process 20. AM process 20 may then assess 404 the target date with respect to the current workflow and/or historical workflow data to determine various relevant information. For example, in certain embodiments AM process 20 may assess the historical time taken for full approval of similar items that were subjected to similar workflow. If, in light of this analysis, the current target publication date appears to be inappropriate (e.g., overly ambitious or overly conservative), AM process 20 may, for example, prompt the revisiting 406 of the selection 402 of a target publication date (and/or various other aspects of the approval workflow, such as the sequence of approvers).

AM process 20 may further notify 214 various approvers 408 of various target dates for approval, including, in certain embodiments, notifying 214 approvers in reverse order of a series of approval (as also discussed above), and may prompt revisiting 410 the selection of a target publication date (and/or various other aspects approval workflow) based upon information received 216 from those approvers. For example, if the collective target dates and approval times requested by the various approvers may result in an untimely completion of the workflow (e.g., with respect to the current target completion date, a recommended target completion date, or an amended target completion date), AM process 20 may, for example, provide relevant information to a workflow administrator and may provide a prompt the administrator to select of an updated target completion date and/or various other workflow parameters.

Upon finalization of a target completion date and workflow, for example, which may follow various iterations of the workflow processes depicted in FIG. 4 (and/or other aspects of AM process 20), the relevant content item may be submitted 412 for approval by the relevant approvers in the appropriate sequence, approval may be obtained 414, and the approved content item may be published 416 (and/or otherwise appropriately distributed or processed). AM process 20 may identify various aspects of the timing of such a workflow (e.g., total time for submission, approval and publication; time for approval by respective approvers; time for submission for approval; and so on), and may amend 226 historical the relevant workflow data appropriately.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of embodiments and implementations have been described. Nevertheless, it will be understood that various modifications may be made. Accordingly, other embodiments and implementations are within the scope of the following claims.

What is claimed is:

1. A computer-implemented method comprising:
identifying, by one or more computing devices, a target completion date for approval of a content item;
identifying, by the one or more computing devices, one or more approvers associated with a sequence of approval for the content item;
determining, by the one or more computing devices, a recommended completion date for the content item based upon, at least in part, historical workflow data; and
determining, by the one or more computing devices, whether timely completion of the approval of the content item is likely, based upon, at least in part, comparing the target completion date with the recommended completion date.

2. The computer-implemented method of claim 1 further comprising:
identifying a last approver in the sequence of approval;
notifying the last approver of one or more of the target completion date and a first amended target completion date, wherein the first amended target completion date is determined based upon, at least in part, determining the recommended completion date; and
receiving an indication of a target receipt date for the last approver based upon, at least in part, notifying the last approver of one or more of the target completion date and the first amended target completion date.

3. The computer-implemented method of claim 2 further comprising:
identifying a previous approver in the sequence of approval, the previous approver preceding the last approver in the sequence of approval;
notifying the previous approver of the target receipt date for the last approver; and
receiving an indication of a target receipt date for the previous approver based upon, at least in part, notifying the previous approver of the target receipt date for the last approver.

4. The computer-implemented method of claim 3 further comprising:
determining a projected total approval time based upon, at least in part, one or more of receiving the indication of the target receipt date for the last approver and receiving the indication of the target receipt date for the previous approver; and
determining a second amended target completion date based upon, at least in part, determining the projected total approval time.

5. The computer-implemented method of claim 1 further comprising:
identifying completion of approval of the content item;
determining an actual approval time associated with the completion of approval; and
amending the historical work flow data to include an indication of the actual approval time.

6. The computer-implemented method of claim 1 further comprising:
determining an amended target completion date based upon, at least in part, determining the recommended completion date,
wherein the recommended completion date is later than the target completion date.

7. The computer-implemented method of claim 6 wherein the recommended completion date is later than the target completion date by more than a threshold percentage of a total project time.

8. A computer program product residing on a non-transitory computer-readable storage medium having a plurality of instructions stored thereon, which, when executed by a processor, cause the processor to perform operations comprising:
identifying a target completion date for approval of a content item;
identifying one or more approvers associated with a sequence of approval for the content item;
determining a recommended completion date for the content item based upon, at least in part, historical workflow data; and
determining whether timely completion of the approval of the content item is likely, based upon, at least in part, comparing the target completion date with the recommended completion date.

9. The computer program product of claim 8 wherein the operations further comprise:
identifying a last approver in the sequence of approval;
notifying the last approver of one or more of the target completion date and a first amended target completion date, wherein the first amended target completion date is determined based upon, at least in part, determining the recommended completion date; and
receiving an indication of a target receipt date for the last approver based upon, at least in part, notifying the last approver of one or more of the target completion date and the first amended target completion date.

10. The computer program product of claim 9 wherein the operations further comprise:
identifying a previous approver in the sequence of approval, the previous approver preceding the last approver in the sequence of approval;
notifying the previous approver of the target receipt date for the last approver; and
receiving an indication of a target receipt date for the previous approver based upon, at least in part, notifying the previous approver of the target receipt date for the last approver.

11. The computer program product of claim 10 wherein the operations further comprise:
determining a projected total approval time based upon, at least in part, one or more of receiving the indication of the target receipt date for the last approver and receiving the indication of the target receipt date for the previous approver; and
determining a second amended target completion date based upon, at least in part, determining the projected total approval time.

12. The computer program product of claim 8 wherein the operations further comprise:
identifying completion of approval of the content item;
determining an actual approval time associated with the completion of approval; and
amending the historical work flow data to include an indication of the actual approval time.

13. The computer program product of claim 8 the operations further comprise:
determining an amended target completion date based upon, at least in part, determining the recommended completion date,
wherein the recommended completion date is later than the target completion date.

14. The computer program product of claim 13 wherein the recommended completion date is later than the target completion date by more than a threshold percentage of a total project time.

15. A computer system comprising:
one or more processor devices; and
one or more memory architectures coupled with the one or more processor devices;
wherein the one or more processor devices are configured to:
identify a target completion date for approval of a content item;
identify one or more approvers associated with a sequence of approval for the content item;
determine a recommended completion date for the content item based upon, at least in part, historical workflow data; and
determine whether timely completion of the approval of the content item is likely, based upon, at least in part, comparing the target completion date with the recommended completion date.

16. The computer system of claim 15 wherein the processor devices are further configured to:
identify a last approver in the sequence of approval;
notify the last approver of one or more of the target completion date and a first amended target completion date, wherein the first amended target completion date is determined based upon, at least in part, determining the recommended completion date; and
receive an indication of a target receipt date for the last approver based upon, at least in part, notifying the last approver of one or more of the target completion date and the first amended target completion date.

17. The computer system of claim 16 wherein the processor devices are further configured to:
identify a previous approver in the sequence of approval, the previous approver preceding the last approver in the sequence of approval;
notify the previous approver of the target receipt date for the last approver; and
receive an indication of a target receipt date for the previous approver based upon, at least in part, notifying the previous approver of the target receipt date for the last approver.

18. The computer system of claim 17 wherein the processor devices are further configured to:
determine a projected total approval time based upon, at least in part, one or more of receiving the indication of the target receipt date for the last approver and receiving the indication of the target receipt date for the previous approver; and
determine a second amended target completion date based upon, at least in part, determining the projected total approval time.

19. The computer system of claim 18 wherein the processor devices are further configured to:
identify completion of approval of the content item;
determine an actual total approval time associated with the completion of approval; and
amend the historical work flow data to include an indication of the actual approval time.

20. The computer system of claim 15 wherein the processor devices are further configured to:
determine an amended target completion date based upon, at least in part, determining the recommended completion date,
wherein the recommended completion date is later than the target completion date.

21. The computer system of claim 20 wherein the recommended completion date is later than the target completion date by more than a threshold percentage of a total project time.

22. A computer-implemented method comprising:
identifying, by one or more computing devices, a target completion date for approval of a content item;
identifying, by the one or more computing devices, a last approver in a sequence of approval associated with the content item;
notifying, by the one or more computing devices, the last approver of the target completion date;
receiving, by the one or more computing devices, an indication of a target receipt date for the last approver based upon, at least in part, notifying the last approver of the target completion date;
determining, by the one or more computing devices, a previous approver in the sequence of approval, the previous approver preceding the last approver in the sequence of approval;
notifying, by the one or more computing devices, the previous approver of the target receipt date for the last approver;
receiving, by the one or more computing devices, an indication of a target receipt date for the previous approver based upon, at least in part, notifying the previous approver of the target receipt date for the last approver;
determining, by the one or more computing devices, a projected total approval time based upon, at least in part, one or more of receiving the indication of the target receipt date for the last approver and receiving the indication of the target receipt date for the previous approver; and
identifying, by the one or more computing devices, a first amended target completion date based upon, at least in part, determining the projected total approval time, wherein the projected total project approval time indicates a likely failure to complete the approval of the content item by the target completion date.

23. The computer-implemented method of claim 22 further comprising:
determining a recommended completion date for the content item based upon, at least in part, historical workflow data; and
determining whether one or more of the target completion date and the first amended target completion date are appropriate for timely approval of the content item, based upon, at least in part, comparing the recommended completion date with one or more of the target completion date and the first amended target completion date.

24. The computer-implemented method of claim 23 further comprising:
identifying a second amended target completion date based upon, at least in part, comparing the recommended completion date with one or more of the target completion date and the first amended target completion date.

25. The computer-implemented method of claim 23 further comprising:
identifying completion of the approval of the content item;
determining an actual approval time associated with the completion of the approval; and
amending the historical work flow data to include an indication of the actual approval time.
